(19) United States
(12) Patent Application Publication
(10) Pub. No.: US 2008/0104438 A1
(43) Pub. Date: May 1, 2008

(54) Microcomputer, program and on-vehicle electronic controller

(75) Inventors: Kouichirou Yokoyama, Anjo-city (JP); Shuichi Nitta, Kariya-city (JP); Shinichi Senoo, Kariya-city (JP); Masaya Hirota, Toyohashi-city (JP); Akihiro Sasaki, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/976,080

(22) Filed: Oct. 19, 2007

(30) Foreign Application Priority Data
Oct. 20, 2006 (JP) 2006-286330

(51) Int. Cl. G06F 1/32

(52) U.S. Cl. 713/323

(57) ABSTRACT

A microcomputer is put into a sleep mode immediately when tasks become ready for the sleep mode so as to eliminate wasted power. Multiple application tasks are executed. Each application task provides notification regarding entry into sleep-ready state. When any application task provides notification, a status management section program sets a flag indicating that the application task goes to the sleep-ready state. The status management section checks flags of all the application tasks to determine whether all the application tasks go to the sleep-ready state, whereupon the microcomputer is put into the sleep mode.

### CROSS REFERENCE TO RELATED APPLICATIONS

The present invention is related to and claims priority from unpublished Japanese Patent Application No. 2006-286330 the contents of which are incorporated herein by reference.

### BACKGROUND OF THE INVENTION

1. Field of the Invention

The present invention relates to the operation of microcomputers. More specifically, the present invention relates to placing a microcomputer in a sleep mode.

2. Description of the Related Art

Conventionally, a microcomputer used in an on-vehicle electronic controller uses a multitasking feature supplied from an operating system (OS) in order to execute multiple application tasks for controlling objects.

When no process is needed, such microcomputer enables sleep mode that consumes less power than a normal operation (see e.g., Japanese Patent Application Laid-open No. JP-2005-182223 A). For example, the sleep mode decreases a CPU clock frequency or a power supply voltage, or stops supplying clocks or power to the CPU.

With reference to FIG. 7, the following describes an example technique of putting a microcomputer into a sleep mode. For the sake of convenience, the present specification makes occasional reference to, for example, a task performing an action signifying the use of, for example, a computer program operating or executing on a hardware device such as a controller or computer as described herein. Use of such an expression can signify that a computer reads instructions from for example, a computer readable medium such as a storage device, data transfer channel, communication channel, or the like and executes the instructions or program in order to implement the operational content, which can be described herein in terms of a functional means or the content of the program function, task, module or the like as would be appreciated by one of ordinary skill.

An example in FIG. 7 makes reference to application tasks 1 and 2. The example also makes reference to a system task that periodically wakes up the application tasks 1 and 2. The system task wakes up every one millisecond and requests to wake up application task 1. The system task requests to wake up application task 2 once every other time the system task wakes up. Therefore, the application task 1 wakes up every millisecond. The application task 2 wakes up every two milliseconds. The tasks are prioritized, for example, in the order of “system task>application task 1>application task 2.”

Each of the application tasks 1 and 2 determines whether any execution is needed and enters a sleep-ready state if a determination is made that no execution is necessary. When it is determined that the sleep-ready state is to be entered, the application task performs a process for setting a sleep flag provided for the task. The system task wakes up to check the sleep flag settings of all the application tasks. When all of the sleep flags are set, the system task performs a procedure to put the microcomputer into the sleep mode, for example, without requesting to wake up the application tasks.

In accordance with the example in FIG. 7, the system task determines that application task 1 goes to the sleep-ready state at time t3 and that the application task 2 goes to the sleep-ready state at time t4. Only when the system task wakes up at time t5, can it put the microcomputer to a sleep mode. As is shown in FIG. 7, the system task wakes up at one-millisecond intervals corresponding, for example, to times t1, t2, and t5. At time t1, the system task wakes up and requests application tasks 1 and 2 to wake. Application task 1 awakens and performs any necessary processing. Since application task 2 is assigned a lower priority than the system task and application task 1, the period for executing application task 2 is the period between the completion of execution of task 1 and the period when the system task awakens at t2. At t3, application 1 goes to sleep ready state and, at t4, application 2 goes to sleep ready state. However, since the system task is still asleep, it will not check the flags until time t5 and place the microcomputer in the sleep mode at the end of the checking procedure.

As noted in connection with the above-mentioned technique where the system task is used to control transition to the sleep mode, the microcomputer cannot be put into the sleep mode until after the system task wakes up even when all the application tasks are in the sleep-ready state. Thus, as is shown in FIG. 7, the time between t4 and then end of t5 represents wasted operation and, accordingly, electric power is wasted.

An idle task can be used as another technique for putting the microcomputer into a sleep mode. However, use of the idle task to control transition to the sleep mode also causes problems similar to those associated with use of the system task for the following reasons. The idle task is given the lowest priority and is executed when no other tasks are executed. Instead of the system task, the idle task checks sleep flags of all the application tasks. When all the sleep flags are set, the idle task performs a process to put the microcomputer into the sleep mode. A state of executing the idle task may equal a state of putting the microcomputer to sleep mode. In such case, the idle task may unconditionally put the microcomputer into a sleep mode even when tasks require execution (see, e.g., JP-2005-182223 A).

Suppose, for example, that the application task 2 is already in the sleep-ready state before time t1. When the system task wakes up at time t1, it requests the application tasks 1 and 2 to wake up. Thus, even if the application task 1 wakes up and goes to the sleep-ready state, the application task 2 is already requested to wake up from the sleep ready state. When the application task 1 terminates, the application task 2 is then executed. When the application task 2 terminates, the idle task puts the microcomputer into the sleep mode.

In the present example however, operation is wasted between the time when the application task 1 terminates and the time when the application task 2 terminates and electric power is again accordingly wasted. Thus, when the idle task is used to control transition to the sleep mode, transition out of the sleep mode may be difficult and it is further difficult to build other functions into the idle task.

### SUMMARY OF THE INVENTION

The present invention has been made in consideration of the foregoing. It is therefore an object of the present invention to quickly put a microcomputer into a sleep mode when possible and prevent electric power from being wasted.

To achieve the above-mentioned object, a microcomputer executes an application task and includes a sleep transition management means.

The sleep transition management means starts when an application task notifies its sleep-ready state, such as a state capable of inactivating the application task. The status management section stores a history of the sleep-ready state attributed to the application task issuing the notification. The status management section checks the history about all application tasks to determine whether or not all the application tasks go to sleep-ready states. When the determination yields an affirmative result, the status management section puts the microcomputer to a sleep mode requiring less power consumption than a normal operation.

The application task performs a notification process for issuing the notification when the application task itself goes to a sleep-ready state.

The microcomputer can go to the sleep mode immediately when all the application tasks go to sleep-ready states and the microcomputer is ready for the sleep mode. It is possible to solve the problem of wasted power in the prior art.

The notification process is preferably performed at the end of the application task since, for example, when the application task issuing the notification terminates, the sleep transition management means determines whether or not all the application tasks go to sleep-ready states. It is thus possible to reliably prevent a sleep mode from occurring during execution of the application task.

It should be noted that an exemplary method is further provided, which can be implemented on a computer, for example, through the execution of a computer program. The exemplary computer program, such as that embodied as instructions read from an article of manufacture including a computer readable medium, allows a computer to perform procedures associated with an exemplary method or function as the sleep transition management means and can be embodied in a microcomputer without using additional hardware.

The exemplary microcomputer is applicable to various embodiments including an on-vehicle electronic controller that is especially requested to reduce the power consumption. The microcomputer can further save the power when the on-vehicle electronic controller is capable of being inactivated.

### BRIEF DESCRIPTION OF THE DRAWINGS

The above and other objectives, features and advantages of the present invention will become more apparent from the following detailed description made with reference to the accompanying drawings. In the drawings:

FIG. 1 is a diagram illustrating a configuration of an on-vehicle electronic controller (ECU) according to one exemplary embodiment;

FIG. 2 is a diagram illustrating a configuration of software executed on an exemplary microcomputer;

FIG. 3 is a flowchart illustrating a process of each application task;

FIG. 4 is a flowchart illustrating a process of a status management section SM;

FIG. 5 is a functional flow diagram illustrating operations in accordance with the exemplary processes shown in FIGS. 3 and 4;

FIG. 6 is a timing diagram illustrating an effect associated with various exemplary embodiments; and

FIG. 7 is a timing diagram illustrating disadvantages associated with the prior art.

### DETAILED DESCRIPTION

The following description of an on-vehicle electronic controller according to one or more exemplary embodiments of the invention is provided. The electronic controller according to the described embodiment or embodiments controls functions associated with vehicle body units such as a power window and a door lock. In the following description, it should be noted that the abbreviation “ECU” can refer herein to an electronic controller, electronic control unit, engine control unit, engine management unit, or the like as would be appreciated by one of skill in the art.

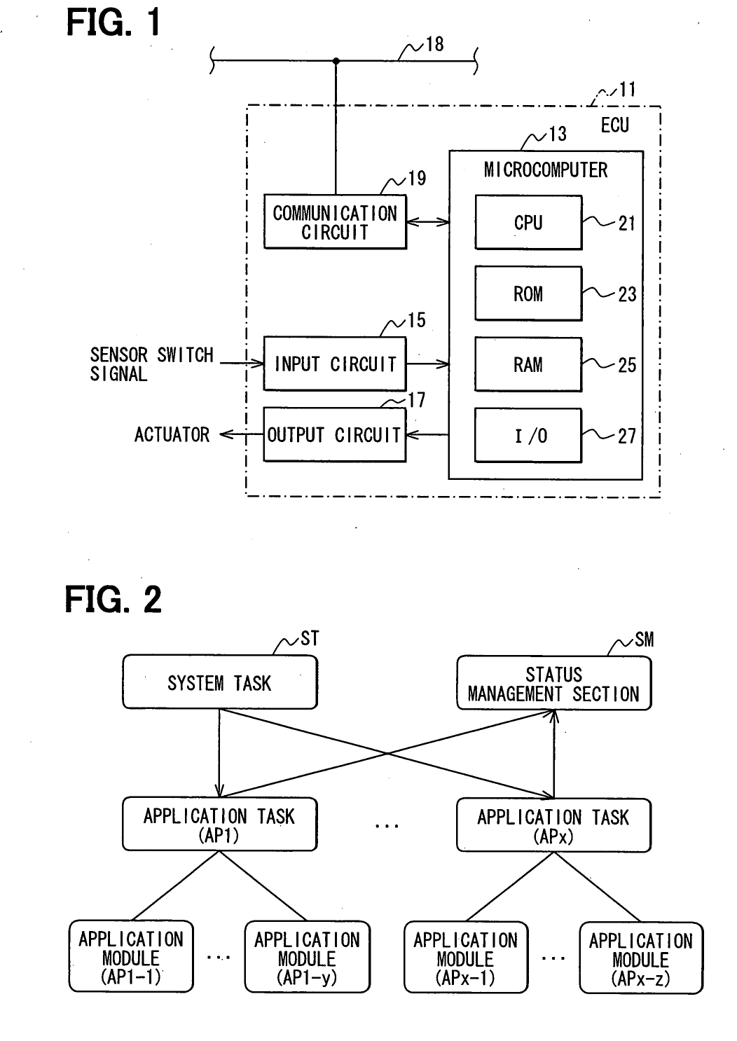

As shown in FIG. 1, an ECU 11 according to the present embodiment includes: a microcomputer 13; an input circuit 15, for example, that allows the microcomputer 13 to receive a sensor signal or a switch signal supplied from a circuit; an output circuit 17, for example, that outputs a drive signal to various actuators associated with, for example, a vehicle body assembly such as a power window motor and a door lock motor, or the like, or other assemblies, based on a signal from the microcomputer 13; and a communication circuit 19 that allows the microcomputer 13 to communicate with another onboard ECU via a communication line 18.

The microcomputer 13 includes well known elements such as, for example, a CPU 21, a ROM 23, a RAM 25, and an I/O port 27. The ROM 23 stores a program, such as a software program having instructions that are executed by the CPU 21. The RAM 25 temporarily stores an operation result from program execution such as data or a flag. It will further be appreciated that the instructions can be carried on other computer readable media such as external memory devices including but not limited to floppy disks, optical disks, universal serial bus (USB) memory devices, network interfaces and the like.

The microcomputer 13 uses the OS-supplied multitasking feature to execute multiple application tasks for interacting with vehicle assemblies to be controlled. The ROM 25 stores software including not only the OS and the application tasks but also a system task ST and a status management section SM.

As shown in FIG. 2, application tasks AP1 through APx, where x is an integer greater than or equal to 2, include applications or tasks associated with applications, or application tasks, that are executed periodically. In a typical execution example, the system task ST requests that the OS wake up the application task at a time corresponding to its execution interval. The system task ST wakes up at an interval equivalent to a least common divisor, such as one millisecond according to the present embodiment, of execution intervals for all the periodic application tasks.

The status management section SM is a program that detects whether all of the application tasks AP1 through APx are ready to become inactive and, of so, puts the microcomputer 13 to the sleep mode.

It will be appreciated that some application tasks immediately wake up upon occurrence of an unscheduled event such as by turning on a specific switch, by receiving a specific signal from another ECU, or the like.

As shown in FIG. 2, each of application tasks AP1 through APx includes one or more modules, which are referred to hereinafter as application modules. For example, the application task AP1 includes as many as y application modules AP1-1 through AP1-y, where y is an integer greater than or equal to 1. The application task APx includes as many as z application modules APx-1 through APx-z, where z is an integer greater than or equal to 1. The application modules provide various levels of control over and interaction with, for example, units, assemblies or the like, such as a door lock unit, a trunk lid control unit, a compartment illumination unit, operating lights, power windows and the like.

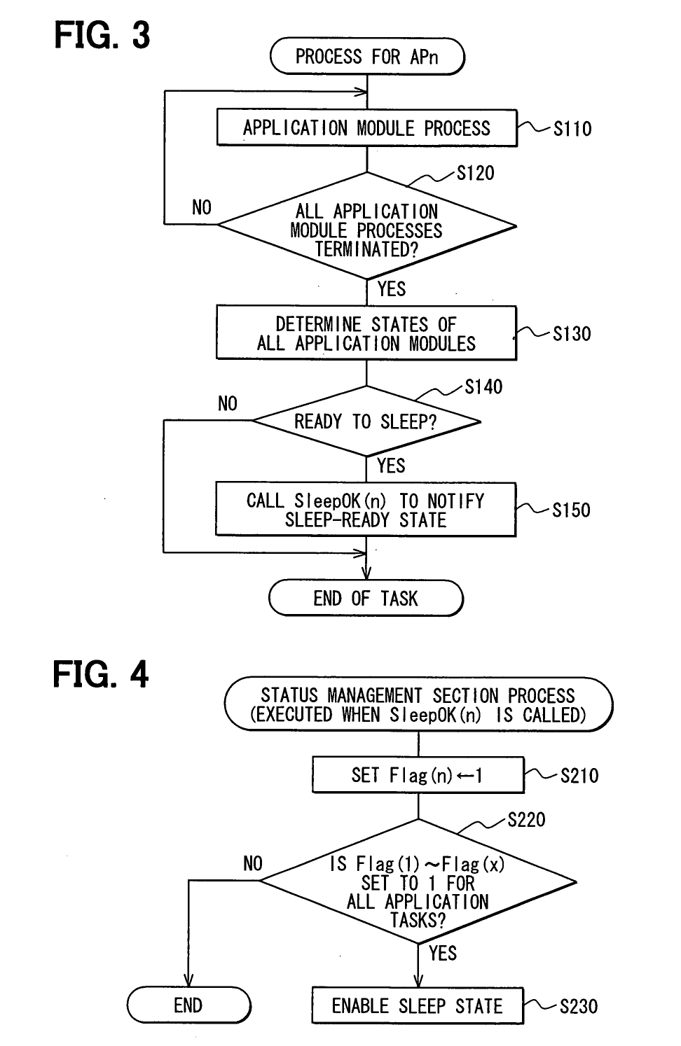

The following describes a process that can be associated with each application task such as a function that is implemented by the application task, with reference for example to the flowchart shown in FIG. 3. While the exemplary process is described in terms of one application task APn, where n is 1 through x, the same description can be applied to other application tasks.

With reference to the flowchart, at the start of the exemplary process, application task APn begins and performs a process associated with, for example, each of the application modules included in application task APn at S110.

When processes of all the application modules terminate, such as YES at S120, application task APn determines whether or not each of all the application modules goes to a sleep-ready state, that is, a state ready to become inactive at S130. It should be noted that an application module will proceed to the sleep-ready state when it has completed any associated control operations and no further control operations need be provided as further described below.

When an application module controls a power window, for example, the application module is executed more than once during a given time interval to implement a sequence of control operations over the power window. When the sequence of controls is complete and no further control requests occur, then it can be considered that, for example, until the next request or sequence of requests is generated, that no further control operations are required. It should also be noted that some application modules go to the sleep-ready state whenever they terminate, such as when no further request or sequence of requests involving control operations are generated.

The exemplary process determines whether or not each of the application modules goes to the sleep-ready state. Based on a determination result, the process determines whether or not application task APn goes to the sleep-ready state (S140). Specifically, the process determines whether or not all the application modules go to the sleep-ready state. When all the application modules go to the sleep-ready state, the process determines that application task APn goes to the sleep-ready state.

When it is determined that application task APn is not in the sleep-ready state, such as a result of NO at S140, application task APn terminates.

When it is determined that application task APn is in the sleep-ready state, such as a result of YES at S140, a notification process can be performed at S150 to notify the status management section SM that application task APn is in the sleep-ready state. According to the present embodiment, the exemplary process calls can call a sleep-ready function, such as SleepOK(n) to perform the notification. It should be noted that the parenthesized n in the sleep-ready function is the function's argument or parameter and can represent, for example, an identifier of the application task that called the function. Application task APn then terminates.

When an application task goes to the sleep-ready state upon completion of execution, it may be preferable in some exemplary embodiments to omit the determinations, for example, at S130 and at S140 and always call the sleep-ready function at the end of the application task.

Referring now to a flowchart of an exemplary procedure shown in connection with FIG. 4, the following describes functions and procedures associated with an exemplary status management section SM, such as an exemplary function implemented by the status management section SM.

While execution is performed, for example, in connection with the microcomputer 13, one of the application tasks AP1 through APx calls the sleep-ready function SleepOK(n) with an argument n having a value of from 1 to x. A program corresponding to the status management section SM is executed immediately.

When the program corresponding to the status management section SM is executed, a sleep-ready flag setting function, such as Flag(n) can be used to set to a sleep-ready flag to 1 at S210. It will be appreciated that the parenthesized argument n associated with the sleep-ready flag setting function can represent, for example, an identifier of the application task that called the sleep-ready function. The sleep-ready flag can be used at S210 to store a history of the sleep-ready state attributed to and notifications provided by the application task.

At S220, it can be determined whether all sleep-ready flags associated with the sleep ready flag setting functions, such Flag(1) through Flag(x), are set for all the application tasks AP1 through APx.

When all the sleep-ready flags associated with the sleep-ready flag setting functions Flag(1) through Flag(x) are set for all the application tasks AP1 through APx, such as a result of YES at S220, the microcomputer 13 can be immediately placed into the sleep mode such that less power is required than that for normal operation at S230. For example, the operation of an oscillation circuit for supplying clocks to the CPU 21 can be stopped or the operation of a power supply circuit for supplying the power to the microcomputer 13 can be stopped. Thus, at S230, the microcomputer 13 can be stopped, or, alternatively, the process at S230 may decrease the clock frequency or the power supply voltage for the CPU 21. Unlike the prior art, no delay is incurred in placing the microcomputer 13, or controller or the like into a sleep mode since there is no waiting for the expiration of an interval at which time a module, such as an idle module or the like checks on the state of execution with regard to sleep.

When the determination at S220 yields a negative result, such as that at least one of the sleep-ready flags is not set, a procedure associated with the status management section SM can be terminated. Alternatively, another process is performed or started whereupon execution associated with the status management section SM can be terminated.

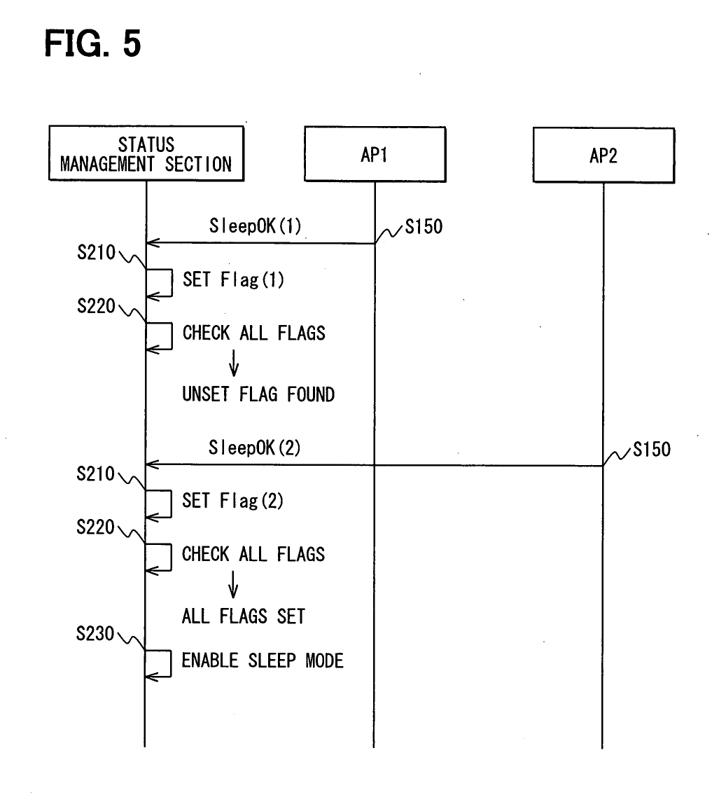

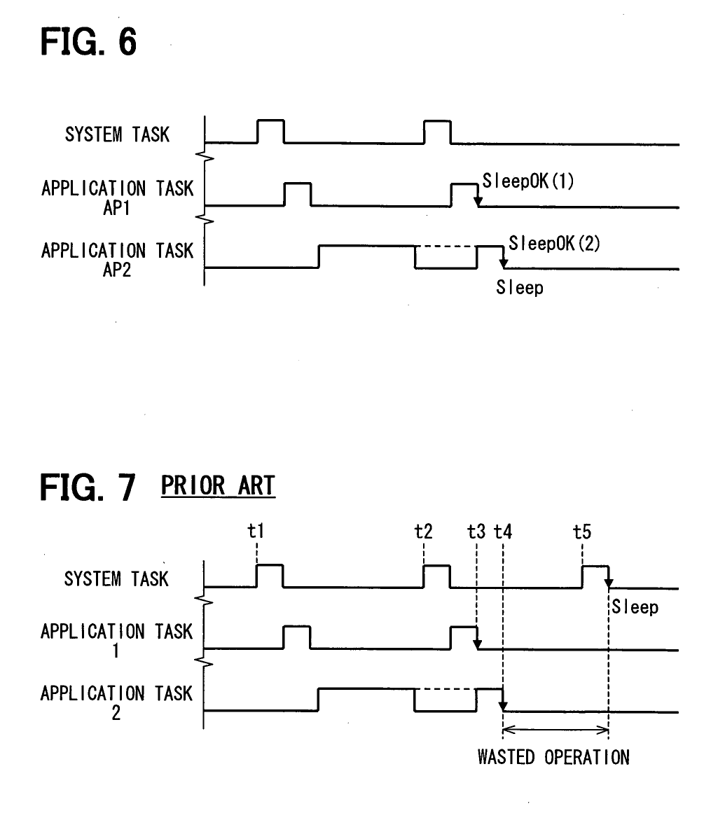

The above-mentioned processes will now be described with respect to FIGS. 5 and 6. In accordance with the example in FIG. 7, it can be assumed that two application tasks AP1 and AP2 are used. The system task ST requests to wake up the application task AP1 every one millisecond and the application task AP2 every two milliseconds. The tasks are prioritized such that the order is as follows. System task ST has a priority that is greater than that of application task AP1, which is great than that of application task AP2 (priST>priAP1>priAP2). It should also be noted that in FIG. 5, the numbers beginning with S correspond to various exemplary procedures shown and described in connection with FIGS. 3 and 4. FIG. 5 shows various functional flows of operation between application tasks and the status management section SM in accordance with various embodiments as a function of time.

As shown in connection with the upper portion of FIG. 5, the application task AP1 calls the sleep-ready function SleepOK(1) such as at S150. Upon receiving the results of the sleep ready operation, the status management section SM begins to set Flag(1) such as at S210. The status management section SM further determines whether or not the sleep-ready flags Flag(1) and Flag(2), are both set for the application tasks AP1 and AP2 such as at S220.

In accordance with the present example of FIG. 5, the sleep-ready flag Flag(2) is not set for the application task AP2. Therefore, the microcomputer 13 does not go to the sleep mode and instead continues normal operation.

Then the application task AP2 calls the sleep-ready function SleepOK(2) which indicates that AP2 application task is ready for sleep. The status management section SM restarts to set Flag(2). The status management section SM determines again whether or not the sleep-ready flags associated with Flag(1) and Flag(2) are both set for the application tasks AP1 and AP2 such as in accordance with S220.

After determining that both sleep-ready flags are set for the application tasks AP1 and AP2, the status management section SM, for example, can perform a process to put the microcomputer 13 to the sleep mode at which point, the microcomputer 13 stops operating. As described above, the transition to the sleep mode can include a decreases of the clock frequency or a decrease of the power supply voltage for the CPU 21 at which point the CPU 21 operates slower than normal at a power level lower than normal resulting in an overall power savings.

As shown in FIG. 6, the microcomputer 13 can go to the sleep mode immediately when all the application tasks go to sleep-ready states. In the present example it can be noted that application task AP2 goes to the sleep-ready state and the microcomputer 13 is ready for the sleep mode. It is therefore possible to solve the problem of wasted power common in the prior art.

It should be noted that the present embodiment can use a computer program to implement the function as the status management section SM. The above-mentioned effect can be provided without using additional hardware. When the idle task is used as the least prioritized task, the idle task can be easily provided with a function such as checking the memory for anomaly.

The ECU 11 using such microcomputer 13 can save the power consumption for the inactive state more effectively than the prior art.

In the present embodiment, the status management section SM is equivalent to a sleep transition management means or a program allowing the computer to function as the sleep transition management means.

While there has been described the specific preferred embodiment of the present invention, it is to be distinctly understood that the invention is not limited thereto but may be otherwise variously embodied within the spirit and scope of the invention. For example, the OS may include functions as the system task ST and the status management section SM. The exemplary process or exemplary procedures associated with the management section SM may be performed in the system task ST or any of the application tasks. An application task or application module may be performed in the system task ST. That is, a given application task may provide control such as waking up tasks in place of the system task ST. While FIG. 2 defines the number of application tasks (x) as two or more, one application task may be used.

It should also be noted that the invention is applicable not only to an ECU for controlling the above-mentioned functions related to the body but also to an ECU for controlling a power train including an engine and a transmission. The invention is also applicable to ECUs used for the other purposes than vehicles.

What is claimed is:

1. A method of controlling a sleep state in controller associated with a vehicle, the controller executing a sleep transition management module and n application tasks, where n is an integer greater than or equal to 2, the n application tasks each having y application modules, where y is an integer greater than or equal to 1, the method comprising:
(a) determining, in association with a first of the n application tasks whether processing associated with all of the y application modules associated with the first of the n application tasks are terminated;
(b) providing a notification to the sleep transition management module of a first sleep ready state associated with the first of the n application tasks if all of the y application modules associated with the first of the n application tasks are terminated;
(c) determining, in association with a next of the n application tasks whether processing associated with all of the y application modules associated with the next of the application tasks are terminated;
(d) providing a notification to the sleep transition management module of a next sleep ready state associated with the next of the application task if all of the y application modules associated with the next of the n application tasks are terminated;
(e) determining, in association with any remaining ones of the n applications tasks whether processing associated with all of the respective ones of the y application modules associated with the any remaining ones of the n application tasks are terminated;
(f) providing a notification to the sleep transition management module, if the any remaining ones of the n application tasks are present, of respective remaining sleep ready states associated with the any remaining ones of the n application tasks if all of the respective ones of the y application modules associated with the any remaining ones of the n application tasks are terminated; and
(g) immediately enabling a sleep mode of the controller based on the notifications provided to the sleep transition management module in (b), (d) and, if the any remaining ones of the n application tasks are present, (f).

2. An article of manufacture comprising:
a computer readable medium; and
instructions carried on the computer readable medium, the instructions readable by the controller, the instructions, when read and executed by the controller, for causing the controller to perform the method according to claim 1.

3. The article of manufacture according to claim 2, wherein the controller includes one of a processor, a microcomputer, and an on-vehicle electronic controller.

4. The method according to claim 1, wherein the sleep transition module is configured to:
start upon the notification of the first sleep ready state associated with the first of the n application tasks;
store a history of sleep-ready states attributed to the first of the n application tasks and attributed to the second of the n application tasks and any remaining ones of the n application tasks, to determine whether all of the n application tasks are in sleep-ready states; and
immediately placing the controller into the sleep mode based on the enabling when all of the n application tasks are in sleep-ready states, the sleep mode requiring less power consumption than a normal operation.

5. A controller executing n application tasks, where n is an integer greater than or equal to 2, the n application tasks each having y application modules, where y is an integer greater than or equal to 1, the controller comprising:
a processor; and
a memory coupled to the processor, the memory capable of storing instructions readable by the processor, the instructions when read and executed for causing the processor to:
execute a sleep transition module, the sleep transition module, upon notification from one of the n application tasks that the one is in a sleep-ready state, configured to:
determine whether all of the n application tasks are in the sleep-ready state; and
immediately place the microcomputer in a sleep mode if all of the n application tasks are in the sleep-ready state, the sleep mode requiring less power consumption than a normal operation,
wherein the notification from the one of the n application tasks is generated when the one of the n application tasks enters a sleep-ready state.

6. The controller according to claim 5, wherein the sleep transition module is further configured to determine whether the all of the n application tasks are in the sleep-read state based on information including a history of previous sleep-ready states associated with one or more of the n application tasks.

7. The controller according to claim 5, wherein the notification from the one of the n application tasks process is generated at an end of execution of the one of the n application tasks.

8. An article of manufacture comprising:
a computer readable medium; and
the instructions carried on the computer readable medium, the instructions readable by the processor, the instructions, when stored in the memory and read and executed by the processor, for causing the processor to perform the function of the sleep transition module according to claim 5.

9. An article of manufacture comprising:
a computer readable medium; and
instructions carried on the computer readable medium, the instructions readable by the microcomputer, the instructions, when read and executed by the microcomputer, for causing the controller to perform the function of the sleep transition module according to claim 6.

10. The article of manufacture according to claim 8, wherein the microcomputer includes one of a processor, a controller, and an on-vehicle electronic controller.

11. The article of manufacture according to claim 9, wherein the microcomputer includes one of a processor, a controller, and an on-vehicle electronic controller.

12. A microcomputer for executing one of a plurality of application tasks, each of the plurality of application tasks executing at least one application module, the microcomputer comprising:
sleep transition management means that, upon notification from the application task regarding entry of the application task into a sleep-ready state, is configured for:
determining whether all of the plurality of application tasks have entered the sleep-ready state, and
causing the microcomputer to be placed in a sleep mode, the sleep mode requiring less power consumption than a normal operation,
wherein the application task performs a notification process for issuing the notification when the application task goes to a sleep-ready state.

13. The microcomputer according to claim 12, wherein the sleep transition management means is further configured for determining whether the all of the n application tasks are in the sleep-ready state based on information including a history of previous sleep-ready states associated with one or more of the n application tasks.

14. The microcomputer according to claim 12,
wherein the notification process is performed at an end of the application task.

15. An article of manufacture comprising:
a computer readable medium; and
instructions carried on the computer readable medium, the instructions readable by the microcomputer, the instructions, when stored in the memory and read and executed by the microcomputer, for causing the microcomputer to operate as the sleep transition management means according to claim 12.

16. An article of manufacture comprising:
a computer readable medium; and
instructions carried on the computer readable medium, the instructions readable by the microcomputer, the instructions, when stored in the memory and read and executed by the microcomputer, for causing the microcomputer to operate as the sleep transition management means according to claim 13.

17. The article of manufacture according to claim 15, wherein the microcomputer includes one of a processor, a controller, and an on-vehicle electronic controller.

18. The article of manufacture according to claim 16, wherein the microcomputer includes one of a processor, a controller, and an on-vehicle electronic controller.
